(19) United States
(12) Patent Application Publication
(10) Pub. No.: US 2026/0194411 A1
(43) Pub. Date: Jul. 9, 2026

(54) NON-CONTACT LEAK DETECTION

(71) Applicant: Nvidia Corporation, Santa Clara, CA (US)

(72) Inventors: Benjamin Goska, Portland, OR (US); Ryan Albright, Beaverton, OR (US); William Andrew Mecham, Elk Grove, CA (US); William Ryan Weese, Portland, OR (US); Aaron Carkin, Hillsboro, OR (US); Michael Thompson, Wilsonville, OR (US); Jordan Levy, Portland, OR (US)

(21) Appl. No.: 19/013,308

(22) Filed: Jan. 8, 2025

(51) Int. Cl. G01M 3/04; G06F 1/20

(52) U.S. Cl. CPC G01M 3/04; G06F 1/20

(57) ABSTRACT

Systems and methods are directed to a leak detection system that incorporates non-contact sensors to detect leaks. The leak detection system may include local power supplies that may provide operational power to the non-contact sensors when remaining components, such as those associated with racks or electronic systems, are shipped, stored, or otherwise not provided with an external power supply. Low-powered non-contact sensors may particularly target small viewing areas for leak detection.

### TECHNICAL FIELD

At least one embodiment pertains to monitoring cooling systems. More specifically, at least one embodiment pertains to non-contact sensors for early leak detection.

### BACKGROUND

Data centers may contain a number of compute units, which may be arranged in a variety of configurations, such as rack-mounted systems that include rows of racks that include a number of different sets of compute units. Compute units may be referred to as heat generating units within a data center and are often configured to run within a given temperature range. More compute-intense operations may generate more heat, which may be beyond the capabilities of air only cooling systems. As a result, data centers may incorporate liquid cooling systems, which may include cooling at a rack-level or at a chip-level, among other options. However, because compute units are sensitive electronic devices, leak detection is used to ensure that leaks can be quickly identified and isolated to reduce damage to electronic components. Typical leak detectors may be positioned within a rack and detect leaks at some threshold that provides sufficient liquid to wet a detector (e.g., physical contact with the leak), by which time the leak may be so severe that several electronic components are damaged.

### BRIEF DESCRIPTION OF THE DRAWINGS

Various embodiments in accordance with the present disclosure will be described with reference to the drawings, in which:

FIG. 1 illustrates an example data center cooling system, according to at least one embodiment;

FIG. 2A illustrates an example data center cooling system, according to at least one embodiment;

FIG. 2B illustrates rack-level features associated with a data center cooling system, according to at least one embodiment;

FIG. 2C illustrates rack-level features associated with a data center cooling system, according to at least one embodiment;

FIG. 3A illustrates an example representation of one or more non-contact sensors associated with areas of interest within an enclosure, according to at least one embodiment;

FIG. 3B illustrates an example schematic representation of fluid detection using a sensor assembly, according to at least one embodiment;

FIG. 3C illustrates an example schematic representation of a sensor assembly, according to at least one embodiment;

FIG. 3D illustrates an example schematic representation of power delivery to sensor assemblies, according to at least one embodiment;

FIG. 3E illustrates an example schematic representation of fields of view for a set of sensor assemblies, according to at least one embodiment;

FIG. 4A illustrates an example schematic representation of a communication system for a set of sensor assemblies, according to at least one embodiment;

FIG. 4B illustrates an example schematic representation of a communication system for a set of sensor assemblies, according to at least one embodiment;

FIG. 5A illustrates an example process for detecting a leak, according to at least one embodiment;

FIG. 5B illustrates an example process for providing operational power to a sensor assembly, according to at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various embodiments are directed toward a leak detection system that incorporates non-contact sensors to detect at least small quantities of fluid (e.g., liquid, gas, solid, combinations thereof) leaks without direct contact with the fluid and/or in scenarios where racks or other systems are not-powered, such as during shipping or at initial installation. In some scenarios, units may be shipped charged with fluid. While waiting for shipment, during shipment, or before installation, leaks (e.g., small leaks) may occur. These small leaks may not be detectable because other leak detection systems, such as in-tray moisture detectors, may be operational with a larger threshold quantity and/or may be powered by an external power supply that is not available until after installation. By waiting until installation to detect leaks, there may be delays and/or damage to the unit that could have been recognized and mitigated earlier. Embodiments of the present disclosure include low-powered (e.g., sufficient for a battery or supercapacitor) non-contact sensors to particularly target small viewing areas for leak detection. As an example, small sensors may include photosensors that are paired with ultra-violet (UV) lights to detect small leaks prior to installation and/or during operation. Because they are small, the sensors may be placed even within trays at critical leak points (connectors, hose clamps, etc.). These sensors can also cover as much area as is visible even covering multiple connectors. Additionally, these sensors may be switched to supplied power after installation and may be tied into an overall leak monitoring and mitigation system. Accordingly, embodiments may be used to address leaks at different phases of storage, shipment, and installation and may further be incorporated into leak management systems as a whole.

One or more embodiments may be directed toward leak detection and mitigation in pre-installation environments, such as storage, shipment, and on-site before installation. A leak detection system may incorporate a plurality of non-contact sensors positioned at individual connection locations for a cooling fluid system associated with an enclosure for one or more processing units. The cooling fluid system may be integrated into a larger cooling system, such as a data center, or may be a localized, sealed or semi-sealed system for a given rack or set of processing units. One or more power supplies may be used to provide operation power for each respective non-contact sensor, even in scenarios where the enclosure is not coupled to an external power supply. In certain embodiments, individual non-contact sensors may have a dedicated power supply. In other examples, multiple non-contact sensors may share one or more power supplies. Furthermore, non-contact sensors may be coupled to multiple power supplies for redundancy. Additionally, the non-contact sensors may be configured to operate using different types of power supplies, such as one power supply when the enclosure is not installed and another after installation. In at least one embodiment, a controller, which may be a portion of a control system that is integrated into a data center and/or may be a remote monitoring control system, may receive one or more signals from one or more non-contact sensors to determine whether a leak is present (e.g., to identify a leak indicator). In some embodiments, the leak indicator may be further correlated to a particular leak location based on a source of the signals. For example, individual non-contact sensors may be positioned within a limited range of view so that an indicator for a given sensor will be correlated to a particular location. The leak information may then be stored for later use and/or analysis, may be used as a trigger to perform one or more actions, and/or combinations thereof.

Various embodiments may include wired or wireless connections between individual non-contact sensors and/or may include wired hubs that are then wirelessly transferred to a central controller, among other connectivity configurations. In certain embodiments, the one or more sensors may include onboard storage that is queried at intervals of time and then overwritten or otherwise deleted. In this manner, leak indicators may be checked at different intervals of time (e.g., every minute, every hour, etc.). Furthermore, as discussed herein, connection may be continuous to provide leak indicators in real or near-real time (e.g., without significant delay). Non-contact sensors of the present disclosure may include different components or sub-components, which may be used to support leak detection and indication. For example, the non-contact sensors may include a photosensor and a UV light emitter. In various embodiments, the cooling fluid may include UV dyes and then, when there is a leak, the UV emitter may be used to illuminate the dye for detection by the photosensor.

Systems and methods of the present disclosure may use one or more sensors (e.g., non-contact sensors) with a pre-installation leak detection system. For example, embodiments may be used during storage and/or shipment to detect leaks prior to installation. Detection of leaks before installation may prevent damage prior to electrical contact, thereby enabling pre-emptive maintenance before installation. Furthermore, detection of leaks during shipment or storage may be used to test packaging and/or shipping methods to improve future developments. Furthermore, leak points may be collected and then used to iterate improved designs to reduce leaks at common leak points, such as by upgrading tubing, modifying connection points, and/or the like. In at least one embodiment, a leak detection system may include a first non-contact sensor positioned at a first cooling fluid connection location for a cooling system, which may include a cooling loop associated with a rack. In at least one embodiment, the first non-contact sensor may include a first photosensor, a first UV emitter, and a first power supply, such as a battery or a supercapacitor. The system may include multiple different sensors to monitor different locations within the rack. For example, the leak detection system may also include a second non-contact sensor positioned at a second cooling fluid connection location for the cooling loop associated with the rack and may include a second photosensor, a second UV emitter, and a second power supply. While this example includes two non-contact sensors using similar detection modalities, it should be appreciated that multiple sensors for a common system may use different modalities. For example, a first modality may be used to detect UV dyes within fluid, another may detect chemical compounds within the fluid, while yet another may detect chemical reactions resulting from leaks, such as a color changing paper. Furthermore, the sensors may also be associated with different filters, such as color filters associated with different additives. The different additives may be associated with different cooling systems or loops, thereby enabling further identification of a leak location and/or leaking system. A control system may be used to receive a first output signal from the first non-contact sensor and a second output signal from the second non-contact sensor indicative of a leak associated with the respective cooling fluid connection location. As discussed herein, the power supplies may enable operation without an external power supply such that each of the first non-contact sensor and the second non-contact sensor are operable when the rack is in transit or during storage within a shipping or storage chain. In operation, detection of a leak may provide an indicator of a leak status and a sensor identification (ID) back to the control system, thereby permitting remedial action and/or recordation for future repairs. The leak status may describe the presence or absence of a leak at a particular location.

Various embodiments may use a variety of small, low-cost sensors within a limited field of view to monitor specific locations for leaks. For example, a low-cost sensor may be arranged at a connection point and may be associated with the particular connection point. As a result, low-cost, low-resolution sensors may be used due to the limited area of operation. By using a non-contact sensor leak detection can be performed without requiring tight connection between the leak point and the sensor. This allows for the sensor to stay installed, even when trays are installed/uninstalled/removed. The non-contact sensor may include a sensor positioned at the specified location with a sensing range within the limited field of view, an emitter associated with the sensor, and a power supply. The emitter may be used to modify one or more properties of the leak to enable the sensor to generate a signal responsive to detecting the leak. In at least one embodiment, the power supply may provide operational power to the sensor and the emitter when the specified location is arranged at a location without an external power supply. Additionally, the sensor and/or the emitter may further be configured to operate using an external power supply when connected to an external power supply. As discussed herein, the sensor may be wirelessly connected to a control system, or may be wired to a control system. In embodiments, the sensor may operate wirelessly when there is no external power and then use a wired system after installation when there is external power. Additionally, the opposite configuration may be used in which the sensor operates on a wired connection when there is no external power and then uses a wireless system to couple to a data center monitoring system. In certain embodiments, communication systems may be blocked or otherwise disabled after installation at the data center, thereby improving data center security.

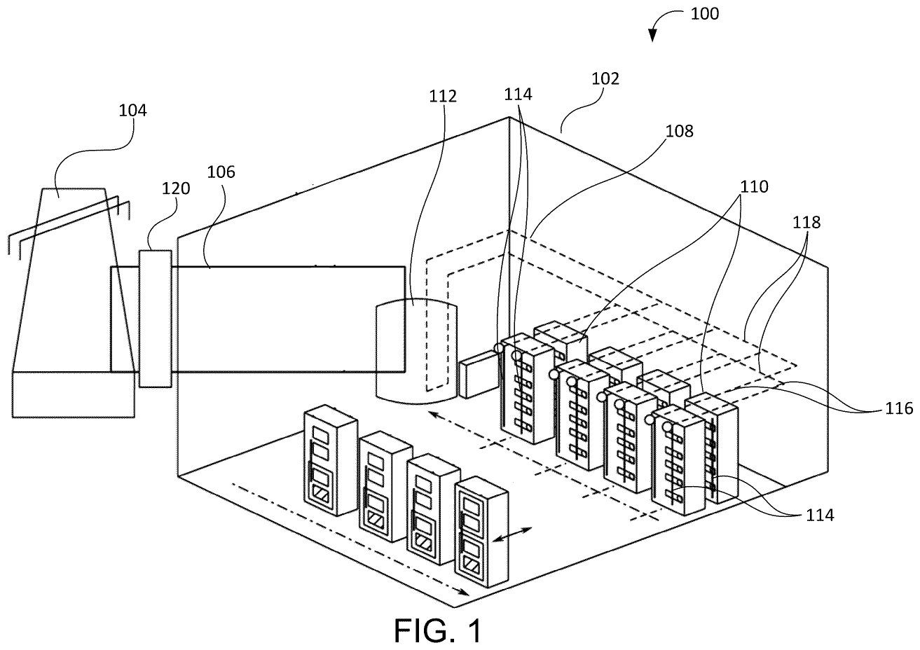

In at least one embodiment, a data center 100 can be utilized as illustrated in FIG. 1, which has a cooling system. In at least one embodiment, numerous specific details are set forth to provide a thorough understanding, but concepts herein may be practiced without one or more of these specific details. In at least one embodiment, data center cooling systems can respond to sudden high heat requirements caused by changing computing-loads in present day computing components. In at least one embodiment, as these requirements are subject to change or tend to range from a minimum to a maximum of different cooling requirements, these requirements must be met in an economical manner, using an appropriate cooling system. In at least one embodiment, for moderate to high cooling requirements, liquid cooling system may be used. In at least one embodiment, high cooling requirements are economically satisfied by localized immersion cooling. In at least one embodiment, these different cooling requirements also reflect different heat features of a data center. In at least one embodiment, heat generated from these components, servers, and racks are cumulatively referred to as a heat feature or a cooling requirement as cooling requirement must address a heat feature entirely.

In at least one embodiment, a data center liquid cooling system is disclosed. In at least one embodiment, this data center cooling system addresses heat features in associated computing or data center devices, such as in Graphics Processing Unit (GPU)s, a Data Processing Unit (DPU), in switches, in dual inline memory module (DIMMs), or Central Processing Unit (CPU)s. In at least one embodiment, these components may be referred to herein as high heat density computing components. Furthermore, in at least one embodiment, an associated computing or data center device may be a processing card having one or more GPUs, switches, or CPUs thereon. In at least one embodiment, each of GPUs, switches, and CPUs may be a heat generating feature of a computing device. In at least one embodiment, a GPU, a CPU, or a switch may have one or more cores, and each core may be a heat generating feature.

In at least one embodiment, a liquid-cooled data center may have a stand-alone or a rack-mount chemistry sensor system as part of one or more sensors of a monitoring system. In at least one embodiment, such one or more sensors are able to perform continuous testing or monitoring of working fluids, such as coolants that are either primary coolant, secondary coolant, or local coolant. In at least one embodiment, secondary coolant may be cooled by a primary coolant, whereas local coolant may be independently cooled or may also be cooled by a primary coolant. In at least one embodiment, upon a change in chemistry determined by at least one processor, additives may be provided for a coolant.

In at least one embodiment, local or other coolant readily available in a preloaded system may be mixed with secondary coolant as an additive. In at least one embodiment, a reservoir of available additives may be provided where such local coolant, primary coolant, secondary coolant, and additives are dispensed using one or more flow controllers. In at least one embodiment, additives may include inhibitors, biocide controls, and other such chemicals used to balance a chemistry of a working fluid, such as of primary coolant, secondary coolant, or local coolant (in itself). In at least one embodiment, such balancing enables optimized chemistry of a coolant within plumbing associated with a data center cooling system. In at least one embodiment, continuous monitoring and chemistry balancing enables a highly efficient operation in a data center cooling system. In at least one embodiment, such plumbing may include cooling distribution units (CDUs), cooling manifolds (or simply referred to as manifolds), tubes, pumps, joints, and cold plates. In at least one embodiment, such working fluid may be used to remove heat from an associated computing device, such as a GPU, a CPU, a switch, or from other components of a server.

In at least one embodiment, a data center 100 can be utilized as illustrated in FIG. 1, which has a cooling system subject to improvements described herein. In at least one embodiment, a data center 100 may be one or more rooms 102 having racks 110 and auxiliary equipment to house one or more servers on one or more server trays. In at least one embodiment, a data center 100 is supported by a cooling tower 104 located external to a data center 100. In at least one embodiment, a cooling tower 104 dissipates heat from within a data center 100 by acting on a primary cooling loop 106. In at least one embodiment, a cooling distribution unit (CDU) 112 is used between a primary cooling loop 106 and a second or secondary cooling loop 108 to enable absorption of heat from a second or secondary cooling loop 108 to a primary cooling loop 106. In at least one embodiment, a secondary cooling loop 108 can access various plumbing into a server tray as required, in an aspect. In at least one embodiment, cooling loops 106, 108 are illustrated as line drawings, but a person of ordinary skill would recognize that one or more plumbing features may be used. In at least one embodiment, flexible polyvinyl chloride (PVC) pipes may be used along with associated plumbing to move fluid along in each provided cooling loop 106, 108. In at least one embodiment, one or more coolant pumps may be used to maintain pressure differences within cooling loops 106, 108 to enable movement of coolant according to temperature sensors in various locations, including in a room, in one or more racks 110, and/or in server boxes or server trays within one or more racks 110.

In at least one embodiment, coolant in a primary cooling loop 106 and in a secondary cooling loop 108 may be at least water and an additive. In at least one embodiment, an additive may be glycol or propylene glycol. In operation, in at least one embodiment, each of a primary and a secondary cooling loops may have their own coolant. In at least one embodiment, coolant in secondary cooling loops may be proprietary to requirements of components in a server tray or in associated racks 110. In at least one embodiment, a CDU 112 is capable of sophisticated control of coolants, independently or concurrently, within provided cooling loops 106, 108. In at least one embodiment, a CDU may be adapted to control flow rate of coolant so that coolant is appropriately distributed to absorbed heat generated within associated racks 110. In at least one embodiment, more flexible tubing of row manifold 114 is provided from a secondary cooling loop 108 to enter each server tray to provide coolant to electrical and/or computing components therein.

In at least one embodiment, tubing of a row manifold 118 that forms part of a secondary cooling loop 108 may be referred to as room manifolds. Separately, in at least one embodiment, further tubing of a row manifold 116 may extend from the tubing of a row manifold118 and may also be part of a secondary cooling loop 108 but may be referred to as row manifolds. In at least one embodiment, coolant tubing of a row manifold 114 enters racks as part of a secondary cooling loop 108 but may be referred to as rack cooling manifold within one or more racks. In at least one embodiment, row manifolds 116 extend to all racks along a row in a data center 100. In at least one embodiment, plumbing of a secondary cooling loop 108, including coolant row manifolds 118, 116, and 114 may be improved by at least one embodiment herein. In at least one embodiment, a chiller 120 may be provided in a primary cooling loop within data center 100 to support cooling before a cooling tower. In at least one embodiment, additional cooling loops that may exist in a primary control loop and that provide cooling external to a rack and external to a secondary cooling loop, may be taken together with a primary cooling loop and is distinct from a secondary cooling loop, for this disclosure.

In at least one embodiment, in operation, heat generated within server trays of provided racks 110 may be transferred to a coolant exiting one or more racks 110 via flexible tubing of a row manifold 114 of a second cooling loop 108. In at least one embodiment, second coolant (in a secondary cooling loop 108) from a CDU 112, for cooling provided racks 110, moves towards one or more racks 110 via provided tubing. In at least one embodiment, second coolant from a CDU 112 passes from one side of a room manifold having tubing of a row manifold 118, to one side of a rack 110 via a row manifold 116, and through one side of a server tray via different tubing of a row manifold 114. In at least one embodiment, spent or returned second coolant (or exiting second coolant carrying heat from computing components) exits out of another side of a server tray (such as enter left side of a rack and exit right side of a rack for a server tray after looping through a server tray or through components on a server tray). In at least one embodiment, spent second coolant that exits a server tray or a rack 110 comes out of different side (such as exiting side) of tubing of a row manifold 114 and moves to a parallel, but also exiting side of a row manifold 116. In at least one embodiment, from a row manifold 116, spent second coolant moves in a parallel portion of a room manifold of a row manifold 118 and is going in an opposite direction than incoming second coolant (which may also be renewed second coolant), and towards a CDU 112.

In at least one embodiment, spent second coolant exchanges its heat with a primary coolant in a primary cooling loop 106 via a CDU 112. In at least one embodiment, spent second coolant may be renewed (such as relatively cooled when compared to a temperature at a spent second coolant stage) and ready to be cycled back to through a second cooling loop 108 to one or more computing components. In at least one embodiment, various flow and temperature control features in a CDU 112 enable control of heat exchanged from spent second coolant or flow of second coolant in and out of a CDU 112. In at least one embodiment, a CDU 112 may be also able to control a flow of primary coolant in primary cooling loop 106.

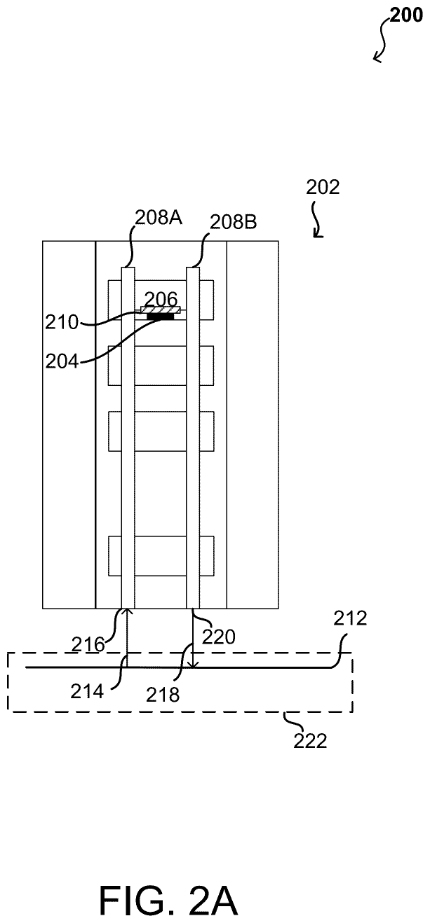

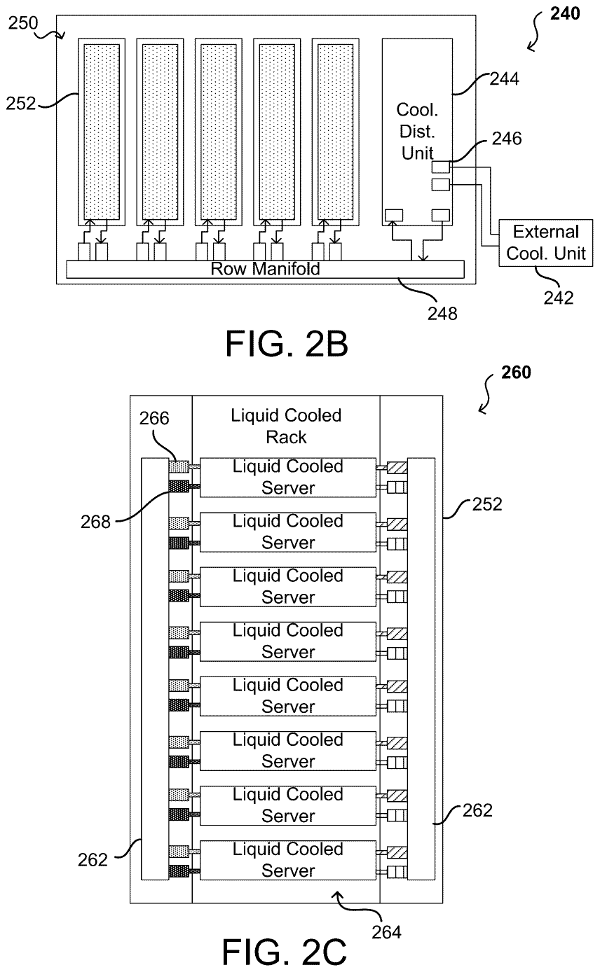

FIG. 2A illustrates an example environment 200 that may be used with embodiments of the present disclosure to provide cooling fluid to one or more computing devices. In this example, a rack 202 is used to house a number of computing devices 204 (e.g., servers, processing units, etc.) in a stacked configuration. The configuration of FIG. 2A may be referred to as showing “rack-level features” for cooling one or more computing devices 204, but embodiments of the present disclosure are not limited to only rack-level cooling and may be expanded to other cooling configurations and arrangements.

The illustrated rack 202 includes a number of shelves 206 that may hold one or more computing devices 204. Each of these shelves 206, and/or the computing devices 204 associated with the shelves 206, may be associated with manifolds 208, which may include an inlet manifold 208A (e.g., a supply manifold) and an outlet manifold 208B (e.g., a return manifold), to provide a cooling fluid to dissipate heat away from the one or more computing devices 204 and then to carry heated fluid away from the one or more computing devices 204. In this example, the manifolds 208 may be coupled to one or more heat plates 210 associated with the one or more computing devices 204, for example via tubing or the like. As discussed herein, the tubing may include plastic tubing, metallic tubing, composite tubing, and/or combinations thereof.

The shelves 206 may also include a variety of different sensors, which may be mounted within the shelf. For example, fluid detectors, such as ribbon detectors, may be positioned within the shelves 206 to detect leaks associated with a cooling fluid system 222. However, these sensors often need a threshold amount of liquid prior to obtaining a signal indicative of a leak. Often, by the time the leak is detected, damage is significant and/or may lead to a sudden preventative action, instead of proactively identifying leaks and then scheduling maintenance. Embodiments of the present disclosure may address and overcome this problem may detecting leaks sooner and at smaller quantities of leaked fluid.

While the illustrated example includes a single inlet manifold 208A and a single outlet manifold 208B, various embodiments may include more manifolds 208 and the manifolds may be arranged at different locations. For example, the manifolds 208 may be arranged at sides of the rack 202 to provide improved access to the interior of the rack, such as the shelves 206. Additionally, in at least one embodiment, the manifolds 208A, 208B may be positioned on opposite sides of the rack 202. Furthermore, embodiments may include multiple manifolds 208, with particular manifolds being used to direct fluid to/from particular shelves 206. Accordingly, a variety of configurations for cooling manifolds may be used within the scope of the present disclosure.

The manifolds 208 are shown coupled to a row manifold 212, which may be part of a secondary cooling loop. The row manifold 212 may include both an “inlet” line that carries cool fluid toward the shelves 206 and an “outlet” line that carries heated fluid away from the shelves 206. The row manifold 212 may include a connection 214 to a source inlet 216 of the manifold 208A and a connection 218 to a source outlet 220. The source inlet 216 may carry the cooled fluid along a length of the manifold to one or more outlets that may direct the cooled fluid toward the heat plates 210. The heat plates 210 may then include different connections to inlets of the manifold 208B that may direct heated fluid to the source outlet 220 to return to the row manifold 212 so that heated fluid may be cooled and then reused. As discussed herein, the row manifold 212 may be part of one or more cooling fluid systems 222, which may include components discussed, for example, in FIG. 1.

FIG. 2B illustrates a system 240 that may be used with embodiments of the present disclosure. The illustrated system 240 may include various features discussed with reference to FIG. 2A and herein, such an external cooling unit 242, such as a cooling tower, which may be part of an overall data center cooling system. This example illustrates the external cooling unit 242 coupled to a cooling distribution unit 244, which may be for a data center as a whole, or in certain embodiments, may be a localized cooling distribution unit at a rack or row level, among other options. The illustrated cooling distribution unit 244 may include a control board 246 to receive data from a variety of sensors associated with the cooling system. For example, the one or more sensors may provide coolant flow rate data, cooling pressure data, status of auxiliary systems, and/or the like.

The illustrated embodiment includes a row manifold 248 that sends/receives cooling fluid to/from the cooling distribution unit 244. The row manifold 248 also distributes and receives cooling fluid from a row 250 of racks 252, which in this example are liquid cooled racks. In at least one embodiment, there can be different levels of flow into, and out of, different liquid cooled racks. Additionally, there may also be different flows into individual servers in a rack. As discussed herein, systems and methods of the present disclosure may be used to form one or more portions of the row manifold 248 and/or may be used as part of a rack-specific manifold, as discussed herein.

FIG. 2C illustrates a system 260 that may be used with embodiments of the present disclosure. This example system includes the rack 252 with rack-level manifolds 262. As shown, the rack 252 includes a number of liquid cooled servers 264 or other such devices. In at least one embodiment, the rack-level manifold 262 provides a flow of liquid into each liquid cooled server 264 through an inlet valve 266, and return liquid with heat removed from that liquid cooled server 264 through an outlet valve 268. In at least one embodiment, sensors can capture information about temperature, fluid flow, or other such aspects of a computing environment internal and/or external to the rack 252, including internal and/or external to any individual liquid cooled servers 264 located therein. Fluid associated with the rack-level manifold 262 may be used to remove an amount of heat from liquid cooled servers 264, but due to factors such as varying load and external temperature fluctuations, temperatures at various locations may change, and may reach or exceed temperature limits at which these devices can continue to operate correctly. In at least one embodiment, an attempt can be made to ensure that temperatures at specific locations remain below an acceptable limit, where those locations may relate to junction temperatures or core temperatures for a processor (e.g., a CPU or GPU), memory module, or power supply.

In at least one embodiment, fluid quality is monitored and controlled at a rack level using one or more assemblies or sensors, for example inline flow sensors that can be associated with the manifold 262 as a whole and/or for individual liquid cooled servers 264. Different racks and servers may have different flow characteristics, such as different diameter flow channels in direct-to-chip cooling boards, and as a result, different cooling configurations, different manifold sizes, and/or different manifold properties may be used.

Systems and methods of the present disclosure address and overcome problems with existing leak detection systems that may have limited detection capabilities with respect to a minimum or threshold quantity of detectable fluid. One challenge with leak detection is detecting leaks quickly to enable rapid remediation before damage occurs to sensitive electronic components. The problems of slow detection may be exacerbated in dense racks where more electronic components are packed into smaller spaces, resulting in dripping liquid possibly spreading to other equipment, such as by the associated fans of the components. While many cooling systems add UV dyes for manual leak inspection, the manual inspections are often delayed until after a threshold quantity of liquid is detected by other sensors. As a result, the UV dye is used for reactive leak detection based on another signal instead of proactive detection prior to large problems, as performed by embodiments of the present disclosure. Embodiments address and overcome these problems, among others, by using low-cost non-contact sensors, such as optical sensors, at various areas to detect leaks. In certain embodiments, sensors may be concentrated at critical areas, such as fluid connections or in dense rack locations. Optical sensors may include photodiodes, image capture devices, and/or combinations thereof. Certain embodiments may use low-cost photodiodes with filters to detect certain reactive colors associated with dyes. The sensor may then transmit a signal for significant increase in a sensed signal, which would be indicative of a leak, which may be recorded for future evaluation and or may lead to an alarm or other indicator to perform manual inspection, among other options. Sensors may be concentrated at critical leak points, may be positioned within available space in dense racks, or may be arranged to cover multiple connections. Systems and methods may use self-powered devices with one or more power supplies, which may power individual sensors or groups of sensors, thereby enabling detection before power is coupled to the rack. Additionally, various embodiments may use selectively disabled wireless connectivity to enable detection prior to installation and then may disable wireless communication to maintain data center security. Accordingly, systems and methods may be used to monitor leaks within data centers or other electronic liquid cooling applications.

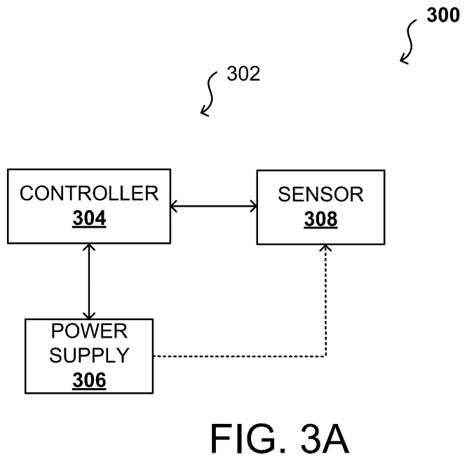

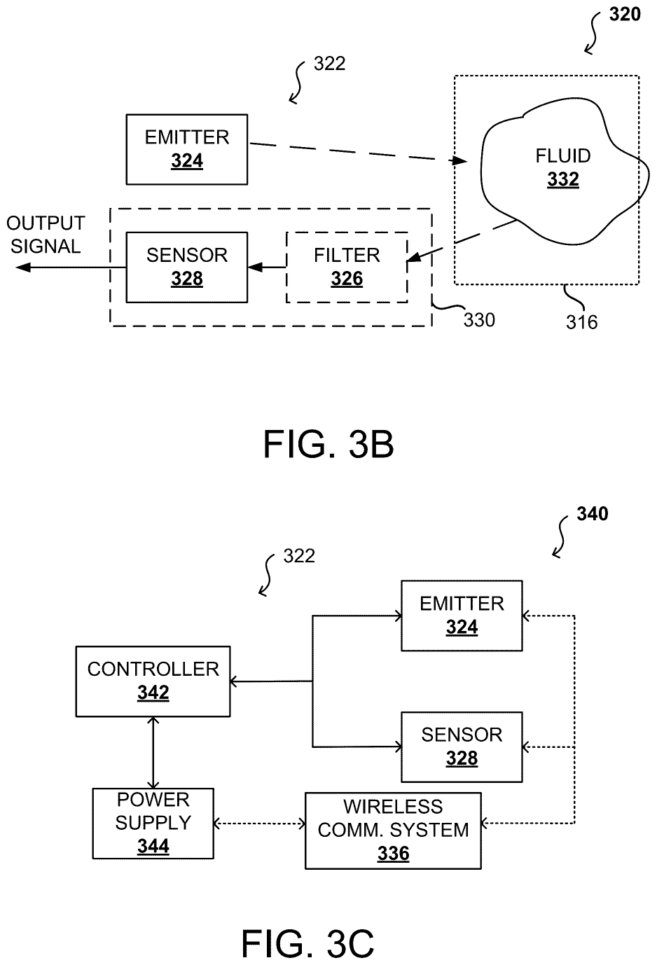

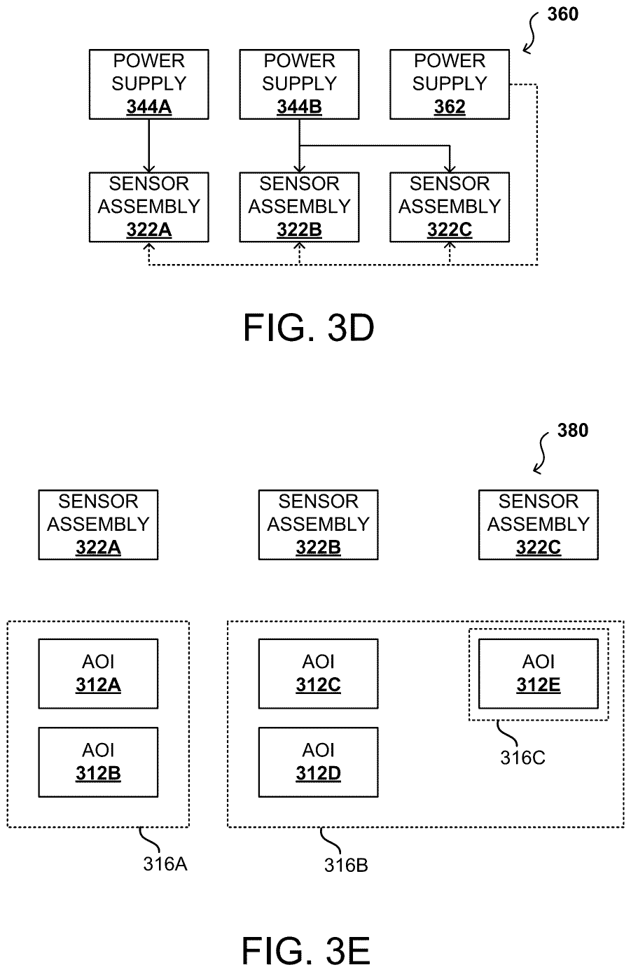

FIG. 3A illustrates an example schematic representation 300 of a non-contact leak detector 302 further including a controller 304 and a power supply 306. Some of all of these components may be arranged within a housing which is not shown for clarity. The controller 304 may be used to send and/or transmit information to/from the sensor element 308. For example, the controller 304 may query the sensor element 328 for a signal. However, in other embodiments, the sensor element 308 may continuously, or at internals, send information back to the controller 304 for evaluation and determination whether a sufficient change has occurred to transmit the output signal. In at least one embodiment, the controller 304 may further include one or more communication devices, such as a wired or wireless transceiver (e.g., a Bluetooth transceiver) that may use one or more low-power protocols to transmit signals to one or more central controllers. As discussed herein, the controller 304 and/or the wireless transceiver may be selectively disabled and/or deactivated after installation of the associated electronic components to maintain data center security requirements. In at least one embodiment, the controller 304 may not include any logic to evaluate the sensor information and may be used to pass through signals.

Furthermore, the controller 304 may also be used to pass through operational power provided by the power supply 306. In at least one embodiment, the power supply 306 may include a supercapacitor or a battery to provide operational power to the components of the sensor element 308, which may all be low-power components. Furthermore, the power supply 306 may also be associated with an external source, such as at a data center, and may be cycle between the two. For example, during shipping or storage, a self-contained power supply may be used and then, after installation, an external power supply may be used. While pass through power from the controller 304 may be used, alternatively and/or additionally, direct power connections between the power supply 306 and/or the sensor element 308 may also be used within the scope of the present disclosure. In example embodiments, the power supply 306 may provide operational power for the sensor element 308 when the data center is not coupled to an external power supply. In other example embodiments, the data center may be coupled to an external power supply, in which case the sensor 308 may receive operational power from both or either the power supply 308 and an external power supply.

FIG. 3B illustrates an example schematic representation 320 that may be used with embodiments of the present disclosure. This illustrated example includes components of a sensor assembly 322 including an emitter 324, a filter 326, a sensor element 328 (e.g., sensor), and a housing 330. The non-limiting example of FIG. 3B may include a photosensor (e.g., photoemission, semiconductor, photovoltaic, thermal, photochemical, etc.) as the sensor element 328, but other embodiments may include different sensor elements, and as a result, may include more or fewer components. In one example, the photosensor may include a charged-coupled device (CCD), a light emitting diode (LED), a photoresistor, or a photodiode that is used to detect changes in a signal and, responsive to a quantity of the change (e.g., more than a threshold), transmit one or more signals indicative of a leak. As another example, the sensor element 328 may react with a gas or other element that is emitted during a leak and transmit an electrical signal responsive to a reaction. In this manner, systems and methods may deploy “non-contact” sensors that are not in direct contact with the leaked fluid, but instead, may visually or chemically determine the leak and provide a signal to make one or more changes or adjustments responsive to the determination.

This illustrated example includes the housing 330 that may be used to hold the sensor element 328 and the filter 326, which may be a color filter to detect a particular dye, such as a UV dye, that is added to a fluid 332 used for cooling one or more electronic components as part of a cooling system. While the emitter 324 is shown separate from the housing 330 in this configuration, it should be appreciated that the emitter 324 may be positioned within the housing 330, within another housing, and/or the like. As the fluid begins to leak, small amounts of fluid may collect within the field of view 316. The emitter 324 may then emit a light to activate the UV dye within the fluid 332, in this non-limiting example. The filter 326 may then be used by the sensor element 328 to detect changes within the field of view 316 and, if the changes are sufficient and/or exceed one or more thresholds, an output signal may be transmitted to provide an alert or other indicator regarding the leak associated with the field of view 316. In certain examples, the signal may be paired or otherwise tagged with an identifier for a particular sensor assembly 322, which may then provide information for the area associated with the leak. As such, it may be beneficial to use sensors with small fields of view over particularly important or critical areas. However, in other embodiments, fields of view may cover multiple areas of interest and/or may cover an entire rack or area. Furthermore, fields of view may overlap between different sensor assemblies, which may leak to two signals that are associated with the same leak.

FIG. 3C illustrates an example schematic representation 340 of a sensor assembly 322 further including a controller 342 and a power supply 344. In example embodiments, the sensor assembly 322 may also refer to a non-contact leak detector. The sensor assembly 322 may be positioned at one or more specified locations and have a sensing range within a limited field of view. Some of all of these components may be arranged within the housing 330, which has been eliminated for clarity. The controller 342 may be used to send and/or transmit information to/from the emitter 324 and/or the sensor element 328. In example embodiments, the emitter 324 may modify one or more properties of a leak to enable the sensor element 328 to generate a signal in response to detecting the leak. As a nonlimiting example, the controller 342 may provide a signal to the emitter 324 to emit UV light within the field of view and then query the sensor element 328 for a signal. However, in other embodiments, the sensor element 328 may continuously, or at internals, send information back to the controller 342 for evaluation and determination whether a sufficient change has occurred to transmit the output signal. In at least one embodiment, the controller 342 may further include one or more communication devices, such as a wired or wireless transceiver (e.g., a Bluetooth transceiver) that may use one or more low-power protocols to transmit signals to one or more central controllers. As discussed herein, the controller 342 and/or the wireless transceiver may be selectively disabled and/or deactivated after installation of the associated electronic components to maintain data center security requirements. In at least one embodiment, the controller 342 may not include any logic to evaluate the sensor information and may be used to pass through signals.

Furthermore, the controller 342 may also be used to pass through operational power provided by the power supply 344. In at least one embodiment, the power supply 344 may include a supercapacitor or a battery to provide operational power to the components of the sensor assembly 322, including at least the sensor element 328 and the emitter 324, which may all be low-power components. Furthermore, the power supply 344 may also be associated with an external source, such as at a data center, and may be cycle between the two. For example, during shipping or storage, a self-contained power supply may be used and then, after installation, an external power supply may be used. While pass through power from the controller 342 may be used, alternatively and/or additionally, direct power connections between the power supply 344 and the emitter 324 and/or the sensor element 328 may also be used within the scope of the present disclosure. In example embodiments, the power supply 344 may provide operational power for at least the sensor element 328 when the data center is not coupled to an external power supply, such as, without limitation, when the specified location of the sensor element 328 is arranged at a location without an external power supply. In other example embodiments, the data center may be coupled to an external power supply, in which case the sensor element 328 may receive operational power from both or either the power supply 344 and an external power supply.

Furthermore, a wireless communication system 336 may be coupled to the sensor 328, the emitter 324, and the power supply 344. In example embodiments, the wireless communication system 336 may transmit a status signal responsive to an input from the sensor 328. The wireless communication system 336 may include a wireless transceiver (e.g., Bluetooth). In other example embodiments, other information may be transmitted over the wireless communication system 336 such as leak location or power supply, and the wireless communication system 336 may also transmit one or more signals or information to the controller 342 even though such a connection is not illustrated in FIG. 3C.

FIG. 3D illustrates an example representation 360 of a set of power supplies 344A, 334B providing operational power to a plurality of sensor assemblies 322A-322C. In this configuration, the power supply 344A only provides power to the sensor assembly 322A. However, as shown, the power supply 344B may be configured to power operational power to both of sensor assemblies 322B, 322C. As a result, a single power supply may be used for operational power for multiple different sensor assemblies. Furthermore, embodiments may mix or otherwise use either configuration, which may also include providing operational power to more than two sensor assemblies. The selection of a number of power supplies to sensor assemblies may be based on a variety of factors, such as size of the power supplies, positions of the sensor assemblies, and/or the like.

As discussed herein, in one or more embodiments, an external power supply 362 may be used to provide operational power to the sensor assemblies 322A-322C, for example, after the sensor assemblies 322A-322C are installed within a data center. In certain embodiments, the power supplies 344A, 344B may be rechargeable and may also receive power from the external power supplies 362. It should be appreciated that in other embodiments the sensor assemblies 322A-322C may be deactivated or otherwise not used after installation.

FIG. 3E illustrates an example representation 380 of fields of view 316 for different sensor assemblies 322. In this configuration, the sensor assembly 322A has a field of view 316A that encompasses both the first area of interest (AOI) 312A and the second AOI 312B. As shown, neither of the sensor assembly 322B or the sensor assembly 322C include the first or second AOIs 312A, 312B within their respective fields of view 316B, 316C. However, in this example, the field of view 316B overlaps with the field of view 316C. For example, the field of view 316 may correspond to the sensor assembly 322B and includes each of the AOIs 312C-312E. In contrast, the field of view 316C only includes the AOI 312E. Accordingly, systems and methods may deploy different configurations of sensor assemblies to monitor different AOIs, which may include different overlapping regions for important areas and/or may include different overlapping regions for different sensor modalities in order to provide redundant checks for important regions.

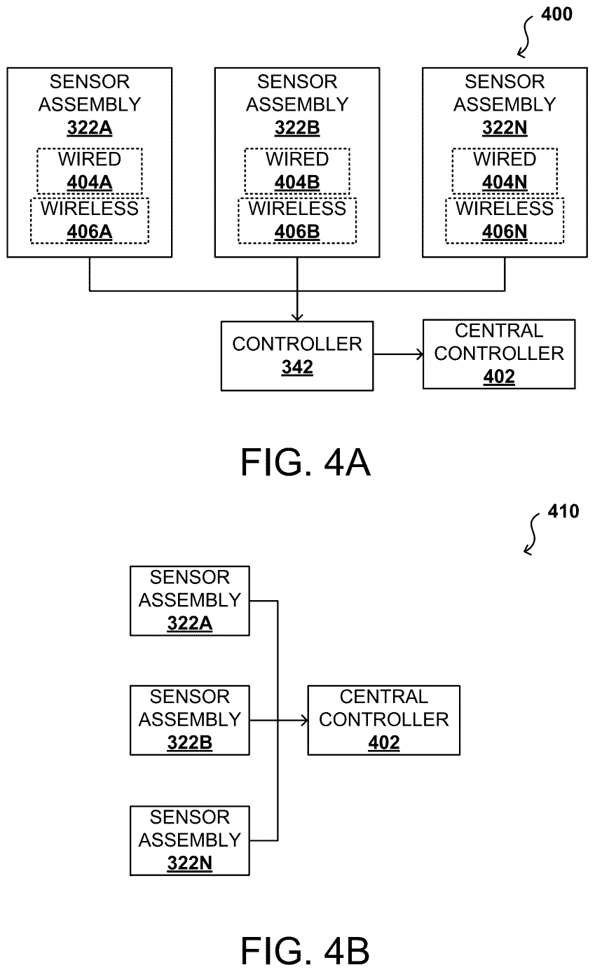

FIG. 4A illustrates an example representation 400 for data communication within a data center regarding leak detection. In this example, the illustrated sensor assemblies 322A-322N transmit information to the controller 342, which may correspond to a controller used to manage or otherwise operate the sensor assemblies 322A-322N, and then the controller 342 transmits information to a central controller 402, which may be associated with one or more controllers of a data center. The central controller 402 may then evaluate information from the controller 342 to determine a response, such as outputting an alarm, performing one or more actions (e.g., shutting down a rack, stopping fluid flow, etc.), and/or the like.

In this example, the connections between the sensor assemblies 322A-322N and the controller 342 and/or the controller 342 and the central controller 402 may be wired or wireless connections. For example, wired communication may use one or more wired transceivers A-N 404 and wireless communications may use one or more wireless transmitters (e.g., transceivers) A-N 406 to transmit information to the controller 342. Similarly, the controller 342 may also be one or both of wired and wireless transceiver to provide information to the central controller 402. Additionally, or alternatively, the connections may be reversed and/or selectable, for example, which may permit either wired or wireless connections based on different operating conditions. It may be desirable to use wired connections in a data center to increase security, but providing the option for wireless communication may be beneficial for pre-installation, such as during storage and shipping. Accordingly, prior to installation, wireless communication may be blocked or otherwise disabled. FIG. 4B illustrates an example representation 410 for data communication within a data center in which the controller 342 is omitted and the sensor assemblies 322A-322N provide information directly to the central controller 402. As discussed herein, the connections may be wired and/or wireless and may be selected based on particular operational conditions.

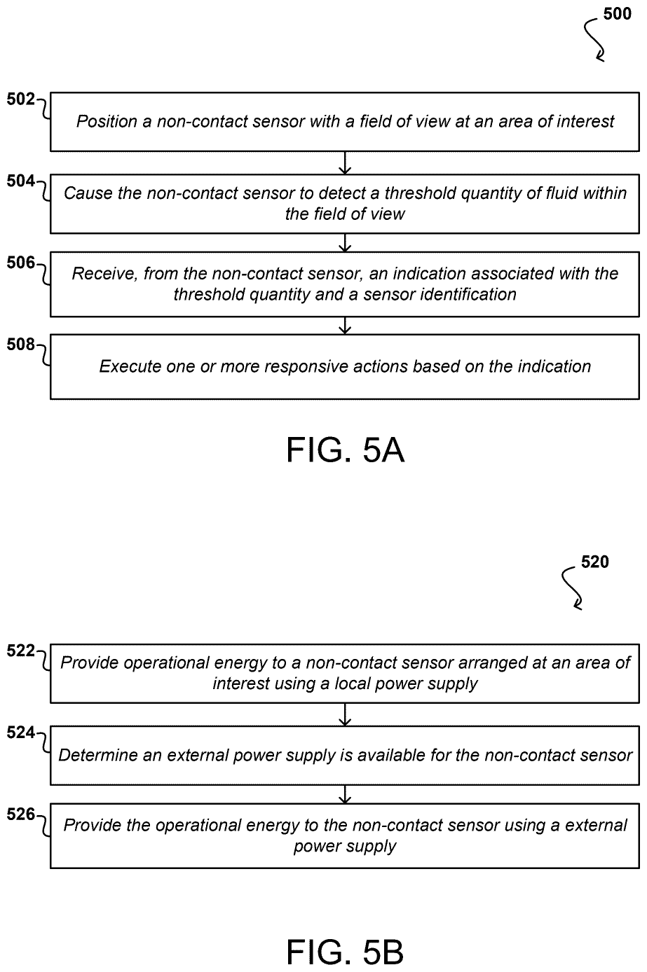

FIG. 5A illustrates an example process 500 for detecting leaks within an area of interest. It should be appreciated that steps for the method may be performed in any order, or in parallel, unless otherwise specifically stated. Moreover, the method may include more or fewer steps. In this example, a non-contact sensor is positioned at an area of interest 502. The non-contact sensor may include a field of view corresponding to an area for detecting one or more leaks. As discussed herein, the field of view may refer to a viewing area for a visual sensor and/or to a volume for chemical sensor, among other options. The non-contact sensor may be used to detect a threshold quantity of fluid within the field of view 504. For example, changes within the field of view from a first time to a second time may be indicative of the quantity of fluid exceeding a threshold. In at least one embodiment, an indication may be received from the non-contact sensor 506. The indication may be associated with the threshold quantity of fluid and may further include a sensor ID. As discussed herein, the sensor ID may be associated with the particular area of interest, which may enable rapid detection of the location of the leak. One or more responsive actions may then be executed 508B. For example, an alarm may be triggered, data may be stored, fluid flow may be stopped, and/or the like.

FIG. 5B illustrates an example process 520 for providing operational power to a non-contact sensor. In this example, operational energy is provided using a local power supply 522. The local power supply may include a battery or supercapacitor may provide power to a single or multiple non-contact sensors. In at least one embodiment, it may be determined that an external power supply is available 524 and then operational power to the non-contact sensor may be switched from the local power supply to the external power supply 526. In this manner, the non-contact sensor may maintain operability in a variety of different conditions.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

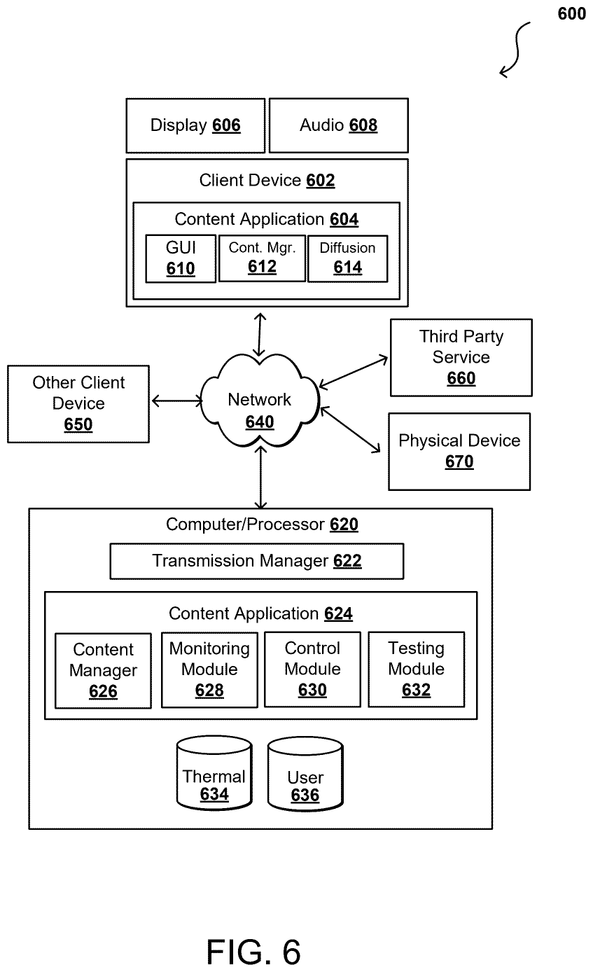

FIG. 6 illustrates an example network configuration 600 of components that can be used to implement aspects of various embodiments, such as to provide, generate, modify, encode, process, fuse, and/or transmit generated image data, calculated measurements, or other such content. In at least one embodiment, a client device 602 can generate or receive data for a session using components of a content application 604 on the client device 602 and data stored locally on that client device. In at least one embodiment, a content application 624 executing on a computer or processor 620 (e.g., a cloud server or control system) may initiate a session associated with at least one client device 602 (e.g., a vehicle or robot), as may use a session manager and user data stored in a user database 636, and can cause content such as liquid coolant or server thermal data to be selected and/or retrieved from a repository 634 to be used by a testing module 632 to calculate one or more performance metrics for a monitoring module 628, which can provide flow data or thermal data to a control module 630 to control a flow or temperature, in an environment where the data is to be used to determine appropriate operation. A content manager 626 may work with at these various modules to perform testing and analysis, and potentially instruct any actions to be taken in response to a performance metric failing to satisfy an operational requirements. At least a portion of this data or instructional content can be transmitted to the client device 602 and/or a physical device 670 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, a flow monitor module 612, and a control module 614 for use in providing, synthesizing, rendering, compositing, modifying, or using content for presentation, navigation, control, (or other purposes) on or by the client device 602, such as may be transmitted to the physical device 670. In some embodiments, the computer/processor 620 and client device 602 may be able to communicate directly without needing to transmit data over a network 640, in order to avoid issues with latency and availability, etc. A decoder may also be used to decode data received over the network 640 for presentation via client device 602, such as imaging content or performance metrics through a display device 606 and audio, such as corresponding sounds or synthesized speech, through at least one audio playback device 608, such as speakers or headphones. In at least one embodiment, at least some of this content may already be stored on, rendered on, or accessible to client device 602 such that transmission over a network 640 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer/processor 620, or user database 636, to the client device 602. In at least one embodiment, at least a portion of this content can be obtained, enhanced, and/or streamed from another source, such as a third party service 660 or other client device 650, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

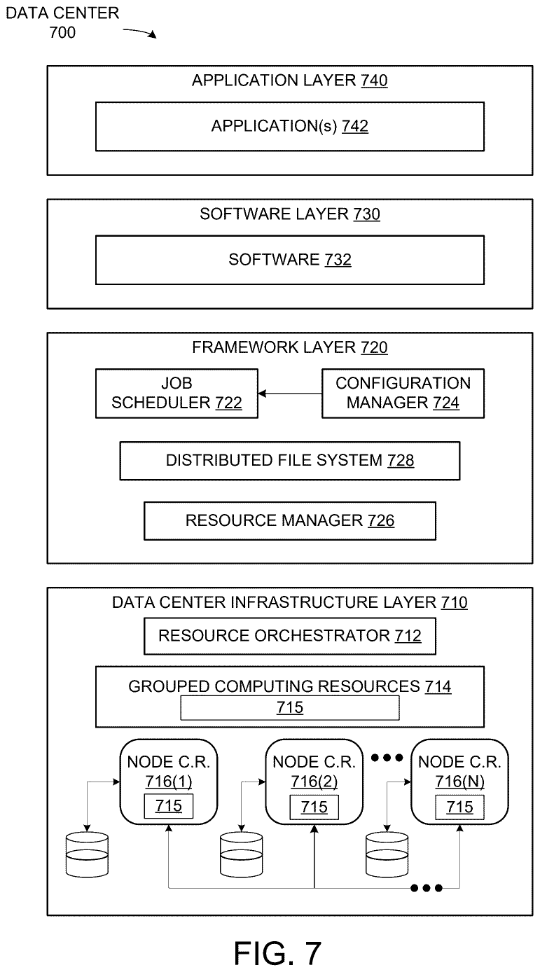

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, DPU, a network interface controller (NIC), FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used in data centers that use liquid cooling systems.

### Computer Systems

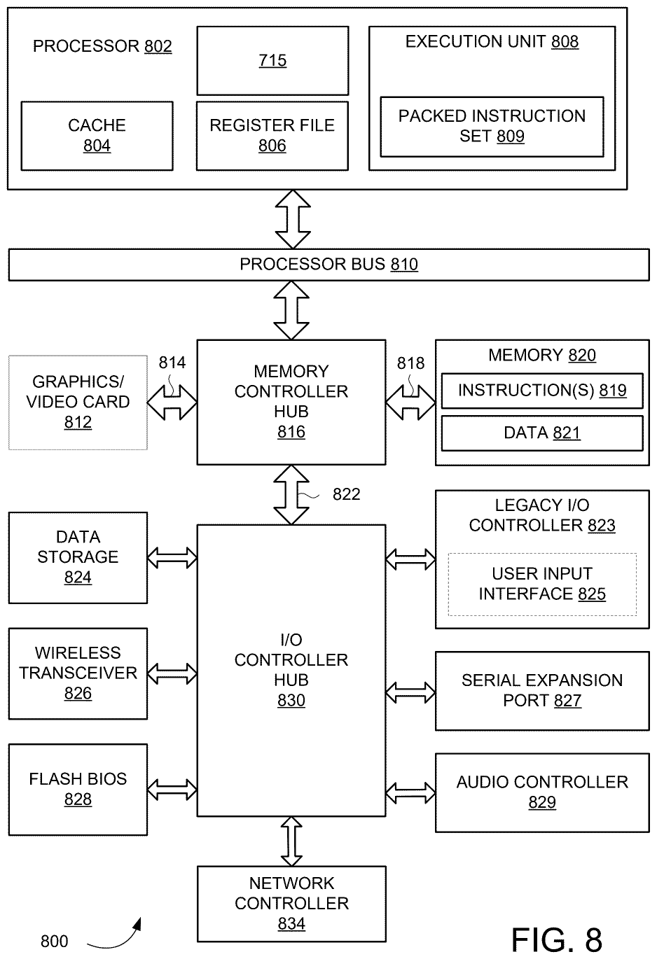

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS′ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used in data centers that use liquid cooling systems.

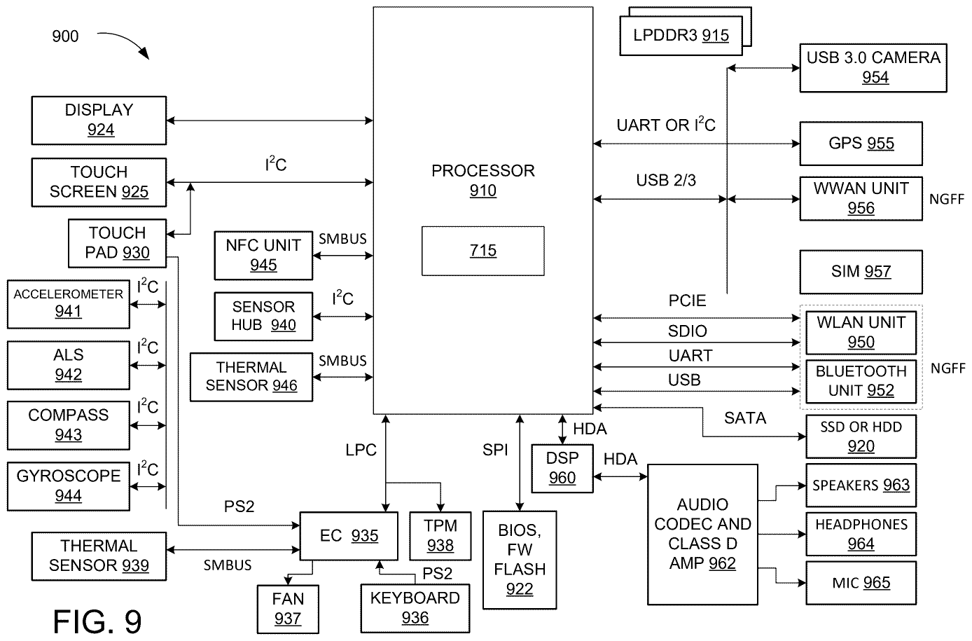

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used in data centers that use liquid cooling systems.

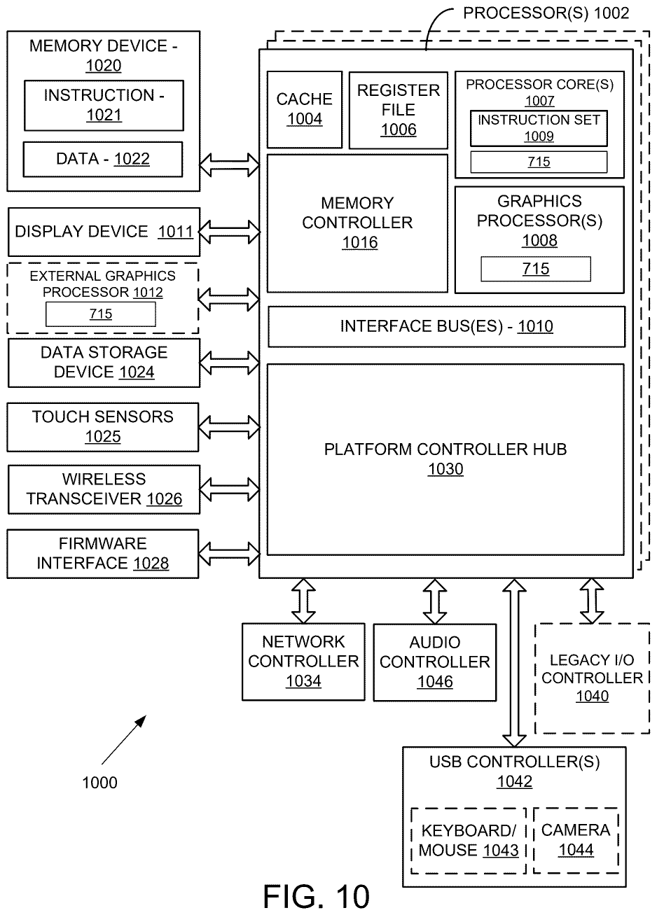

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used in data centers that use liquid cooling systems.

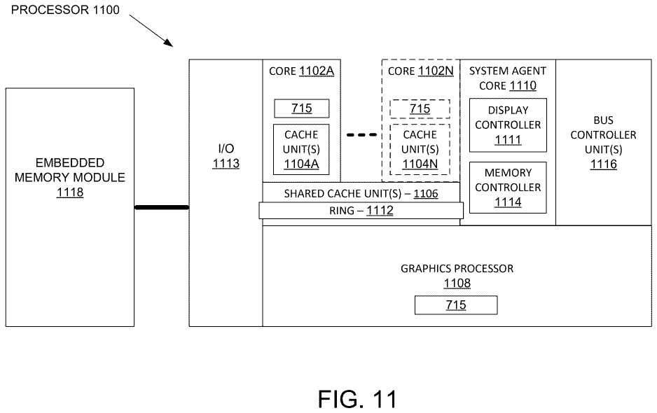

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption coupled with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment, portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used in data centers that use liquid cooling systems.

Various embodiments can be described by the following clauses:
1. A leak detection system, comprising:
   a plurality of non-contact sensors positioned at individual connection locations for a cooling fluid system associated with an enclosure for one or more processing units;
   a plurality of power supplies to provide operational power for each respective non-contact sensor; and
   a controller to:
   determine, based on a signal from a non-contact sensor of the plurality of non-contact sensors, a leak indicator and a leak location; and
   store the leak indicator and the leak location.
2. The leak detection system of clause 1, wherein the controller is coupled to the plurality of non-contact sensors using at least one of a wired connection or a wireless connection.
3. The leak detection system of clause 1, wherein the plurality of non-contact sensors receive operational power from the external power supply when the enclosure is coupled to the external power supply.
4. The leak detection system of clause 1, wherein individual fields of view for the plurality of non-contact sensors are substantially restricted to the individual connection locations.
5. The leak detection system of clause 1, wherein individual non-contact sensors of the plurality of non-contact sensors comprise:
   a photosensor; and
   an ultraviolet (UV) emitter.
6. The leak detection system of clause 1, further comprising:
   a first power supply of the plurality of power supplies coupled to a first non-contact sensor of the plurality of non-contact sensors; and
   a second power supply of the plurality of power supplies coupled to a second non-contact sensor and a third non-contact sensor of the plurality of non-contact sensors.
7. The leak detection system of clause 1, further comprising:
   a plurality of wireless transmitters associated with individual non-contact sensors of the plurality of non-contact sensors, wherein the plurality of wireless transmitters are operable prior to installation of the enclosure at an end location and inoperable after installation of the enclosure at the end location.
8. The leak detection system of clause 1, wherein the enclosure is not coupled to the external power supply during at least one of storage or shipping.
9. a system, comprising:
   a first non-contact sensor positioned at a first cooling fluid connection location for a cooling loop associated with a rack, the first non-contact sensor comprising:
   a first photosensor;
   a first ultraviolet (UV) emitter; and
   a first power supply;
   a second non-contact sensor positioned at a second cooling fluid connection location for the cooling loop associated with the rack, the second non-contact sensor comprising:
   a second photosensor;
   a second ultraviolet (UV) emitter; and
   a second power supply; and
   a control system to receive a first output signal from the first non-contact sensor and a second output signal from the second non-contact sensor indicative of a leak associated with the respective cooling fluid connection location, wherein each of the first non-contact sensor and the second non-contact sensor are operable when the rack is in transit or storage within a shipping or processing chain and not receiving external operational power.
10. The system of clause 9, wherein the first non-contact sensor further comprises:
   a color filter associated with the first photosensor, wherein the color filter is particularly selected based on one or more additives associated with a cooling fluid of the cooling loop.
11. The system of clause 9, wherein the controller is coupled to at least one of the first non-contact sensor or the second non-contact sensor using at least one of a wired connection or a wireless connection.
12. The system of clause 9, wherein the first output signal includes a leak status and a sensor identification.
13. The system of clause 12, wherein the sensor identification is associated with the first cooling fluid connection location and only the first non-contact sensor is positioned to detect the leak at the first cooling fluid connection location.
14. The system of clause 9, wherein at least one of the first non-contact sensor or the second non-contact sensor receive operational power from an external power supply when the rack is receiving external operational power.
15. The system of clause 9, wherein the rack is not receiving external operational power during at least one of storage or shipping.
16. The system of clause 9, wherein at least one of the first power supply or the second power supply is a battery or a super capacitor.
17. A non-contact leak detector, comprising:
   a sensor positioned at the specified location with a sensing range within a limited field of view;
   an emitter associated with the sensor, the emitter to modify one or more properties of the leak to enable the sensor to generate a signal responsive to detecting the leak; and
   a power supply to provide operational power to the sensor and the emitter when the specified location is arranged at a location without an external power supply.
18. The non-contact leak detector of clause 17, further comprising:
   a wireless communication system coupled to the sensor, the emitter, and the power supply, wherein the wireless communication system transmits a status signal responsive to an input from the sensor.
19. The non-contact leak detector of clause 18, wherein the status signal comprises a leak status and an identification associated with the sensor.
20. The non-contact leak detector of clause 17, wherein the specified location is at a cooling fluid connection within a rack and the rack is in a shipping or processing chain.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A leak detection system, comprising:
a plurality of non-contact sensors positioned at individual connection locations for a cooling fluid system associated with an enclosure for one or more processing units;
a plurality of power supplies to provide operational power for each respective non-contact sensor; and
a controller to:
determine, based on a signal from a non-contact sensor of the plurality of non-contact sensors, a leak indicator and a leak location; and
store the leak indicator and the leak location.

2. The leak detection system of claim 1, wherein the controller is coupled to the plurality of non-contact sensors using at least one of a wired connection or a wireless connection.

3. The leak detection system of claim 1, wherein the plurality of non-contact sensors receive operational power from the external power supply when the enclosure is coupled to the external power supply.

4. The leak detection system of claim 1, wherein individual fields of view for the plurality of non-contact sensors are substantially restricted to the individual connection locations.

5. The leak detection system of claim 1, wherein individual non-contact sensors of the plurality of non-contact sensors comprise:
a photosensor; and
an ultraviolet (UV) emitter.

6. The leak detection system of claim 1, further comprising:
a first power supply of the plurality of power supplies coupled to a first non-contact sensor of the plurality of non-contact sensors; and
a second power supply of the plurality of power supplies coupled to a second non-contact sensor and a third non-contact sensor of the plurality of non-contact sensors.

7. The leak detection system of claim 1, further comprising:
a plurality of wireless transmitters associated with individual non-contact sensors of the plurality of non-contact sensors, wherein the plurality of wireless transmitters are operable prior to installation of the enclosure at an end location and inoperable after installation of the enclosure at the end location.

8. The leak detection system of claim 1, wherein the enclosure is not coupled to the external power supply during at least one of storage or shipping.

9. A system, comprising:
a first non-contact sensor positioned at a first cooling fluid connection location for a cooling loop associated with a rack, the first non-contact sensor comprising:
a first photosensor;
a first ultraviolet (UV) emitter; and
a first power supply;
a second non-contact sensor positioned at a second cooling fluid connection location for the cooling loop associated with the rack, the second non-contact sensor comprising:
a second photosensor;
a second ultraviolet (UV) emitter; and
a second power supply; and
a control system to receive a first output signal from the first non-contact sensor and a second output signal from the second non-contact sensor indicative of a leak associated with the respective cooling fluid connection location, wherein each of the first non-contact sensor and the second non-contact sensor are operable when the rack is in transit or storage within a shipping or processing chain and not receiving external operational power.

10. The system of claim 9, wherein the first non-contact sensor further comprises:
a color filter associated with the first photosensor, wherein the color filter is particularly selected based on one or more additives associated with a cooling fluid of the cooling loop.

11. The system of claim 9, wherein the controller is coupled to at least one of the first non-contact sensor or the second non-contact sensor using at least one of a wired connection or a wireless connection.

12. The system of claim 9, wherein the first output signal includes a leak status and a sensor identification.

13. The system of claim 12, wherein the sensor identification is associated with the first cooling fluid connection location and only the first non-contact sensor is positioned to detect the leak at the first cooling fluid connection location.

14. The system of claim 9, wherein at least one of the first non-contact sensor or the second non-contact sensor receive operational power from an external power supply when the rack is receiving external operational power.

15. The system of claim 9, wherein the rack is not receiving external operational power during at least one of storage or shipping.

16. The system of claim 9, wherein at least one of the first power supply or the second power supply is a battery or a super capacitor.

17. A non-contact leak detector, comprising:
a sensor positioned at the specified location with a sensing range within a limited field of view;
an emitter associated with the sensor, the emitter to modify one or more properties of the leak to enable the sensor to generate a signal responsive to detecting the leak; and
a power supply to provide operational power to the sensor and the emitter when the specified location is arranged at a location without an external power supply.

18. The non-contact leak detector of claim 17, further comprising:
a wireless communication system coupled to the sensor, the emitter, and the power supply, wherein the wireless communication system transmits a status signal responsive to an input from the sensor.

19. The non-contact leak detector of claim 18, wherein the status signal comprises a leak status and an identification associated with the sensor.

20. The non-contact leak detector of claim 17, wherein the specified location is at a cooling fluid connection within a rack and the rack is in a shipping or processing chain.
